(19) United States
(12) Patent Application Publication
(10) Pub. No.: US 2010/0269112 A1
(43) Pub. Date: Oct. 21, 2010

(54) SYSTEM AND METHOD FOR THE DYNAMIC DEPLOYMENT OF DISTRIBUTED TREATMENTS

(75) Inventors: Mario Lopez-Ramos, Paris (FR); Jérémie Leguay, Paris (FR); Vania Conan, Paris (FR)

Correspondence Address: STROOCK & STROOCK & LAVAN LLP, 180 MAIDEN LANE, NEW YORK, NY, 10038, US

(73) Assignee: THALES, Neuilly Sur Seine (FR)

(21) Appl. No.: 12/621,730

(22) Filed: Nov. 19, 2009

(30) Foreign Application Priority Data
Nov. 21, 2008 (FR) 08/06553

(51) Int. Cl. G06F 9/46; G06F 15/16

(52) U.S. Cl. 718/100

(57) ABSTRACT

System enabling the dynamic deployment and/or the creation of tasks within a network comprising at least one master node (0) and several sensor nodes Ni having limited processing capacities, the network supporting a communications software application exposing the functionalities of each sensor node as services on the said network and a mediation mechanism allowing communications between the services of various sensor nodes of the said network to be established characterized in that it comprises at least the following elements:
At a low-capacity node Ni of the network:
   A task or processing operations deployment manager (40),
   A storage module (41) for the said tasks received via a deployment manager for the tasks (40),
   A processor module (43) for the said tasks, the said module using basic operations (44) present in the said node,
   An interface with local sensors (45),
   A service oriented network communications module (47),
   A global mediation module (46),
      the said various sensor nodes within the said network each executing one or more of the specific deployed tasks,
At a master node used in the deployment phase:
   A task deployment manager (56).

Use of the system for data fusion.

The invention relates to a system and a method that notably enables the dynamic deployment of tasks or processing operations, such as services distributed within a wireless network of sensors. The sensor network can be an ad hoc network within which each unit, for example a node, communicates directly with its neighbour.

The invention is notably applicable in multi-level architectures. It is used in wired or wireless networks, and more generally in any network comprising nodes having limited processing capacity.

Wireless sensor networks, known by the abbreviation WSN, are composed of nodes characterized by the fact that they have radio communications capability, measurement capabilities via the use of transducers or of more complex modules, and of varying degrees of computing capability. These sensor nodes are usually networked using self-organizing functions like ad-hoc networks (better known as MANET RFC2501). In this case, since communication is in principal only possible between nodes within radio range, a routing protocol, known to those skilled in the art, then provides the relaying of data packets in order to guarantee connectivity from end to end when the network topology permits it. In WSN networks, the nodes may be mobile or otherwise. WSN networks have civilian applications for surveillance of critical infrastructures (classified factories, bridges), environmental monitoring (earthquake risks, agriculture, ecology), certain medical applications or for logistics, or alternatively military applications relating to surveillance missions.

The processing capacities of the sensor nodes encountered in WSN networks can be very variable depending on the equipment deployed. This could be deployable radar equipment requiring processing capabilities similar to those found on large servers, IP cameras having the capacity of a PDA (Personal digital Assistant) of small sensors called ‘motes’, such as the MICAz marketed by the company Crossbow, which are very limited in capacity: in computation power, low-capacity batteries, in limited bandwidth. The method according to the invention is notably applicable to WSN networks having low capacities. These WSN networks are more often than not connected to an information processing system in order to provide the data acquisition, to carry out more complex data fusion processing operations, or to guarantee their control and their reconfiguration. Owing to the complexity and to the variability of these information processing systems, SOA (Service Oriented Architecture) architectures are becoming more popular and deployed more often. The set of architecture principals defined for SOAs allows the functions to be separated into individual autonomous units, called Services, which may be distributed within the network, combined, and reused in order to create applications or other services. The major advantages of this approach are modularity, flexibility, low-level coupling and interoperability. Thus, the use of the SOA approach is particularly well suited to WSN networks. However, although the SOA architecture principals are often used on equipment having capacities at least of the order of those of a PDA, they are rare in very low capacity wireless sensor networks. In the present application, the term ‘very low capacity’ is aimed at equipment such as MICAz fitted with a microcontroller using a few kilobytes of RAM (e.g. 4 kb), with a low-power radio interface, and with limited battery power, for example two R6 batteries or any other type of system with equivalent characteristics. In data fusion operations involving WSN networks composed of very low capacity nodes, saving resources is vital to ensuring the survival of the network. Thus, in order to avoid the sensors sending the data they collect through a sink to a fusion centre situated outside of the WSN, it is preferable to distribute the processing operations over the data as much as possible so as to reduce communications costs. Reducing the communications costs mainly allows the lifetime of the WSN network to be extended by saving the batteries of the nodes. For example, when looking for a maximum, the sensors will be able, from neighbour to neighbour, to find this maximum value in a distributed fashion. Intermediate processing operations, used in the framework of a distributed fusion service, are limited by the capacity of the nodes receiving them. Thus, on MICAz, operations for filtering (e.g. threshold, Kalman filter), aggregation (e.g. average, sum, max-min) and conditional decisions (e.g. hierarchical classification) can be performed.

Service oriented approaches for wireless sensor networks have been the object of several studies. One specification known to those skilled in the art has defined an application layer introducing the concept of hosting service. Gateways allow Zigbee equipment networks to be interconnected (http://fr.wikipedia.org/wiki/zigbee) with the Web Services environment, notably a protocol stack designed for DPWS Web Services. Other authors have proposed a communications protocol at the applications level called μSOA. This protocol allows wireless sensor onboard Web Services to be accessed via a gateway. The WSN-SOA protocol stack (J. Leguay, M. Lopez-Ramos, K. Jean-Marie, V. Conan. An Efficient Service Oriented Architecture for Heterogeneous and Dynamic Wireless Sensor Networks, IEEE SenseApp 2008) was introduced in the framework of a service-oriented multi-level architecture for sensor networks. This architecture is just as applicable to sensors having capacities similar to a PC, a PDA or to a MICAz sensor. The WSN-SOA stack allows services to be deployed in networks with very low capacities. It therefore allows support for data exchange between sensors but does not provide any specific functionality for fusion and the dynamic deployment of services.

Dynamic deployment of processing operations has also been the subject of proposals. One known solution is a system allowing wireless sensors to be totally reprogrammed by remotely re-flashing their memories.

Another known solution is a middleware for WSN networks allowing the use of mobile agents. Mobile agents are defined in the form of a programme with a syntax of a complexity similar to that of the assembler, interpreted on the sensors. Despite the fact that this middleware offers a wide range of operations, it takes up 3191 bytes of RAM in the MICAz only equipped with 4 Kb, which makes its availability incompatible with service-oriented protocol stacks such as those of WSN-SOA and also with the implementation of operations used for data fusion.

TENET architecture, O. Gnawali, B. Greenstein, K. Jang, A. Joki, J. Paek, M. Vieira, D. Estrin, R. Govindan, E. Kohler, The TENET Architecture for Tiered Sensor Networks, In Proc. ACM Sensys 2006, allows the processing operations to be distributed to the sensor nodes in the form of tasks. This allows the communications costs to be reduced by carrying out pre-processing on the sensors and also simple reconfiguration operations to be supported. However, TENET does not allow the sensors to collaborate with each other. The Telnet protocol stack is limited to the deployment of simple processing operations on the nodes. Each node is seen in an isolated and atomic fashion. Telnet does not allow the manner in which the tasks are to interact in distributed mode on the various low-capacity nodes to be defined.

The DAViM system (a Dynamically Adaptable Virtual Machine for Sensor Networks) proposed by Michiels et al., IEEE DISTRIBUTED SYSTEMS ONLINE, IEEE SERVICE CENTER, NEW YORK, NY, US, vol. 8, no. 1, 1 Jan. 2008, page 1, XP011204623, ISSN: 1541-4922, enables the parallel execution of several programmes (or tasks) and the addition on the fly of new instructions (‘operation libraries’) in the virtual machine according to the operational requirements. This system allows developers to re-deploy, for re-configuration operations, very light applications. This proposal does not address the communications between sensor nodes aspects nor does it provide support for collaboration.

The RASA architecture (Resource-Aware Service Architecture for Mobile Services in Wireless Sensor Networks) proposed by Blumenthal et al., COMPUTING IN THE GLOBAL INFORMATION TECHNOLOGY, 2006,ICCGI 2006. INTERNATIONAL MULTI-CONFERENCE ON BUCHAREST, ROMANIA 01-03 AUGUST 2006, PISCATAWAY, N.J., USA, IEEE, 1 Jul. 2006, XP031056602, ISBN: 978-0-7695-2629-4, allows new code to be injected on the fly into a sensor network in the form of ‘mobile agents’, small programmes that propagate from node to node in a viral fashion and are executed on all the nodes. With the aim of being reused, the basic functionalities are separated into ‘modules’ that can be concatenated in order to accomplish tasks (that they name ‘services’). In the case of the method of the present invention, the nodes have non-uniform functionalities (for example detection and warning) and each one executes a different code, while at the same time collaborating in order to accomplish a single global mission. The SOA approach of the method according to the invention allows, in changing environments, nodes having different functionalities to be uncovered and to dynamically concatenate their functionalities according to the context in order to accomplish a task in a collaborative manner.

In summary, the prior art known to the Applicant does not allow the way of integrating and establishing collaboration between all the individual processing operations deployed on networked sensor nodes to be defined in a simple and flexible manner. In particular, their teaching does not allow the following operations to be defined:
distribution of the processing operations involving the collaboration of the WSN nodes.
making the mechanisms for processing distribution over the WSN nodes interoperate with the existing mechanisms (or making the existing software applications interoperate for the dynamic deployment of processing).

Some definitions and reminders useful for the understanding of the present Patent application will be given herein below.

The description is aimed at multi-level architectures allowing the integration of all the non-uniformity of the sensors, in terms of their variable processing capacities, present in a complex system.

In the multi-level architecture, three categories of nodes according to their network capacities and to their availability will be considered:

‘high capacity nodes’; the availability of these nodes is high given that they are permanently connected to the information processing system. They have no power supply problems and have a large processing capacity. (As an example, cartographic information servers connected to infrastructure networks may be mentioned.);

‘limited capacity nodes’; these nodes have limited capacities in terms of storage, batteries, computation power or network connectivity but can host operating systems such as the open software GNU/Linux (fr.wikipedia.org/wiki/Linux) or VxWorks (fr.wikipedia.org/wiki/VxWorks) and can carry out complex processing operations. These can be gateways, or sensor systems of variable performance (optronics, acoustics, etc.);

‘WSN nodes’; these nodes have extremely limited capacities. They are, for example, equipped with a few kbytes of RAM (Random Access Memory), only have one micro-controller and use a low-power radio technology such as the IEEE 802.15.4 standard. MICAz systems marketed by Crossbow are one example of equipment found in this category.

The integration of a WSN network into a complex system is achieved by using ‘master nodes’ that can be ‘high-capacity nodes’ or limited capacity nodes. In a complex information processing system, a WSN network is seen through master nodes as a sub-system. This terminology will be used to describe the subject of the present Patent application.

The idea of the present invention rests notably on the dynamic deployment of the data fusion services within low-capacity sensor networks, some examples of which have been previously given. The system notably offers the advantage of distributing processing operations within a wireless sensor network in order to create an optimised fusion service.

The invention relates to a system enabling the dynamic deployment and/or the creation of tasks within a network comprising at least one master node and several sensor nodes Ni having limited processing capacities, the network supporting a communications software application exposing the functionalities of each sensor node Ni as services on the said network and a mediation mechanism allowing communications between the services of various sensor nodes of the said network to be established, characterized in that it comprises at least the following elements:
At a low-capacity node Ni of the network:
   A task or processing operations deployment manager,
   A storage module for the said tasks received via a deployment manager for the tasks,
   A processor module for the said tasks, the said module using basic operations present in the said node,
   An interface with local sensors,
   A service oriented network communications module, exposing the functionalities internal to other nodes of the network via input and output interfaces and allowing the said services to be controlled on other nodes,
   A global mediation module dynamically establishing communications between the tasks and services producers and consumers of data within the various nodes, delivering and consuming one or more of the said services via the service oriented communications module,
      the said various sensor nodes within the said network each executing one or more of the specific deployed tasks which communicate in order to globally accomplish a mission,
At a master node only during the deployment phase:
   A task deployment manager.

The module for the basic operations of a node Ni of the network comprises at least one operation allowing a task executed on the said node to dynamically create a new service which will be exposed across the said network.

The said global mediation module for the services of a node Ni of the network comprises at least one module for uncovering the new services offered by one or more of the other nodes of the network.

The invention also relates to a system for the dynamic creation of services or of distributed processing operations according to the method described hereinabove, characterized in that it comprises a tool allowing a description of the behaviour of a distributed processing operation to be globally generated starting from a library of basic functions and a module transforming the said description into a set of individual tasks designed to be deployed on each of the sensor nodes Ni.

According to one variant embodiment, at least one node comprises a service gateway designed to ensure interoperability between the tasks being executed on sensor nodes Ni having limited processing capacities and services or tasks being executed on unconstrained nodes or on an information processing system.

The system for global description of the distributed processing operation and the library of basic functions allow tasks to be defined that are designed for nodes having non-uniform processing capacities, and the associated deployment module allows individual tasks generated to be deployed over nodes with non-uniform capacities, communicating via the said service gateway.

The system comprises, for example, a module for supervision and management of the tasks deployed, allowing the execution of the tasks deployed over the sensor nodes to be simulated, tested, supervised and reconfigured using the description of the global behaviour of the distributed processing operation.

According to one embodiment, the service oriented network communications module is a stack of the WSN-SOA type.

Other features and advantages of the device according to the invention will become more apparent upon reading the description that follows of one non-limiting exemplary embodiment, to which are appended the figures which show:

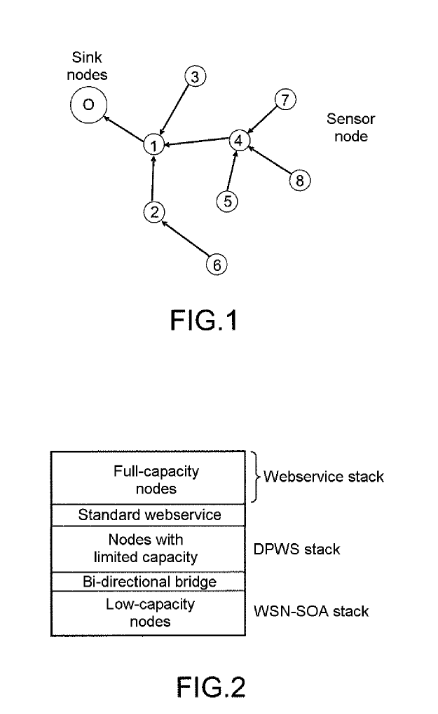

FIG. 1, an example of distributed fusion service,

FIG. 2, various examples of service oriented technologies that can be used at various levels of architecture,

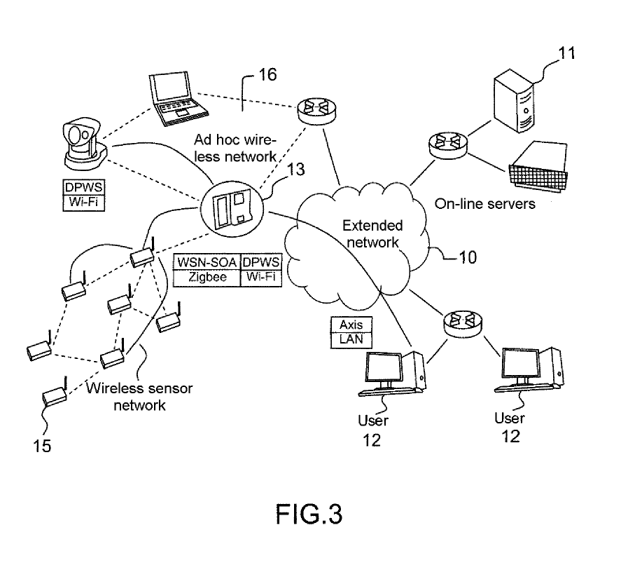

FIG. 3, an example of implementation of sensor resource and processing collaboration in a complex information processing system,

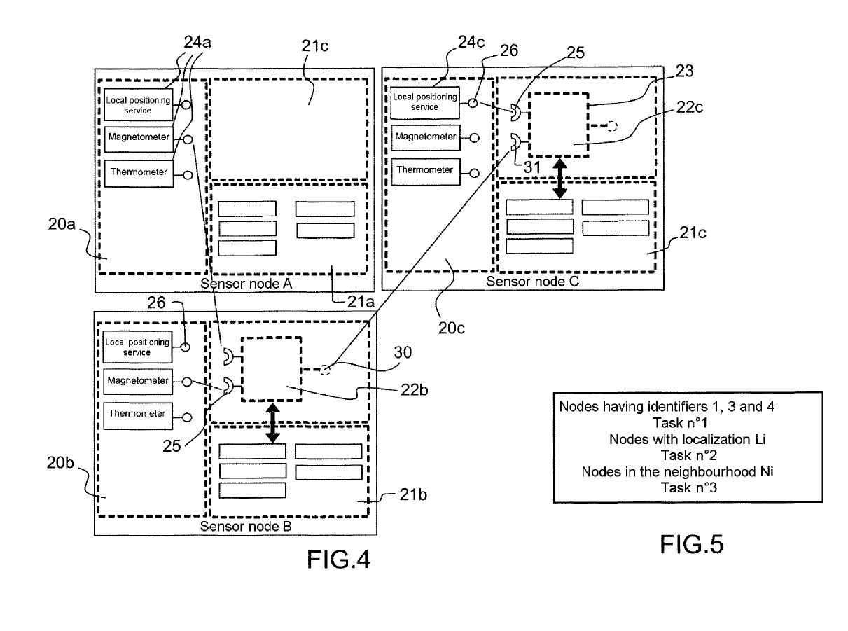

FIG. 4, an example of deployment of services,

FIG. 5, an example of master file,

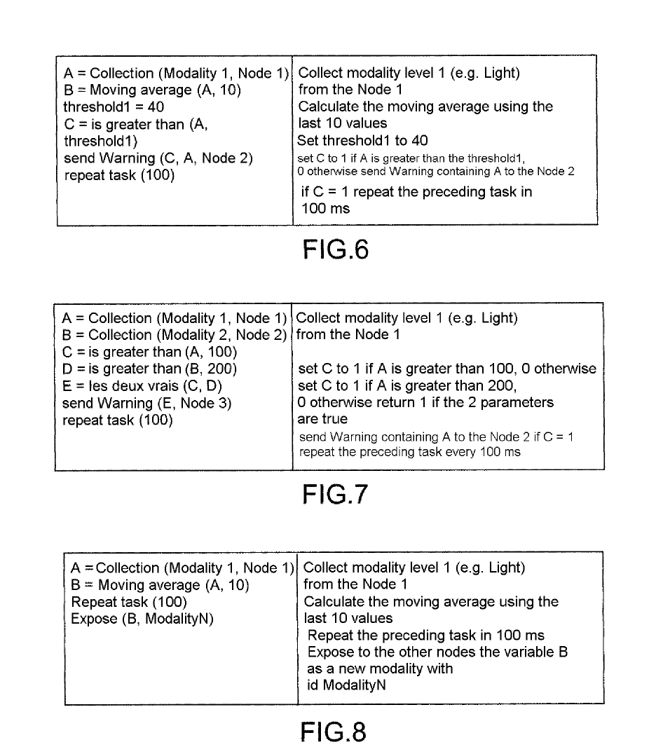

FIGS. 6, 7 and 8, various examples of tasks,

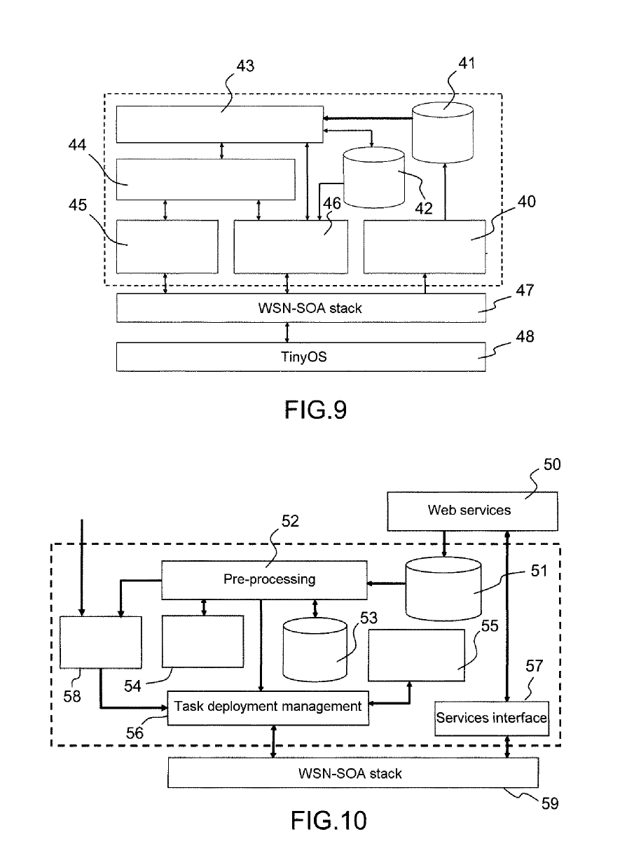

FIG. 9, an example of implementation of the method in the sensor nodes with a WSN-SOA stack and a TinyOS environment,

FIG. 10, an example of implementation of the method in a master node of the network,

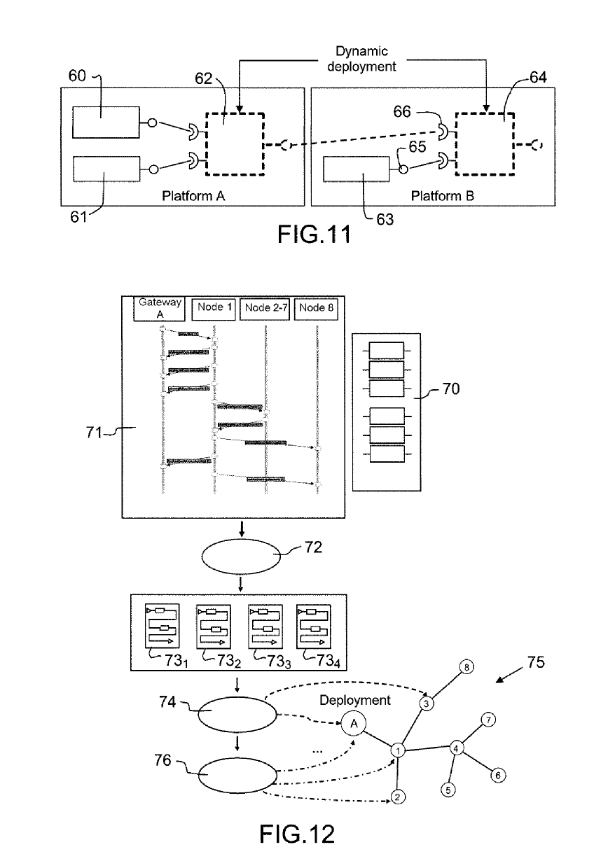

FIG. 11, an example of distributed deployment of fusion modelled using choreographies and orchestrations.

In order to facilitate understanding of the principal implemented by the invention, the following description is presented by way of example for a wireless network of sensors in order to create an optimised fusion service.

FIG. 1 shows an example of distributed fusion service in a network comprising a master node 0 or sink node and several sensor nodes which process the data measured in a hierarchical manner. In this example, all the nodes Ni, numbered from 1 to 8, measure a physical parameter, for example the temperature, and are coordinated to feedback the maximum value in a distributed fashion to the sink node, also referred to as master node in the present description. Thus, by applying hierarchical processing deployed over all the sensor nodes, the node 4 will recover the values measured by the nodes 4, 5, 7 and 8 and will report to the node 1 the maximum value from amongst the temperature values measured by the nodes 4, 5, 7 and 8.

More complex services may of course be implemented. For example, a distributed detection algorithm based on a decision tree can be used. In this case, the intermediate decisions are taken by the various sensor nodes, which will allow a decision to be reached. Such a way of operating allows many communications to be avoided.

FIG. 2 shows one example of multi-layer architecture and examples of service oriented technologies SOA that can be used at the various nodes of the architecture. A Web Services stack can be implemented at high-capacity nodes, the DPWS (Devices Profile for Web Services) stack for the limited capacity nodes, and the WSN-SOA stack for the WSN nodes.

The architecture presented in FIG. 2 allows distributed fusion services involving sensor resources and processing operations to be implemented in a complex information processing system as is shown schematically in FIG. 3. This FIG. 3 shows the implementation of sensor resource collaboration and of processing operations in a complex information processing system. Such a system enables the fusion of data coming from the sensor resources.

The architecture described in FIG. 3 comprises a wide area network 10 or WAN to which various elements may be connected, such as on-line services 11, various users 12, gateways to a sensor network 13, enabling a wireless sensor network 15 to communicate with the rest of the information processing system. In this example, an ad hoc wireless network 16 is also connected with 13. The steps of the method according to the invention allow the user 12 to implement collaboration between the non-uniform resources of the information processing system (sensors of the sensor network 15, IP camera for example).

The method according to the invention requires a certain number of software and protocol components in order to function:

In the most generic case, a middleware application enables communications between the various nodes of the network and the various elements implemented by the method according to the invention, together with a routing mechanism enabling messages to be relayed between the nodes. The communications middleware comprises, for example, functions enabling data to be exchanged, for example, by invocation, by subscription or alternatively by publication, and the exposure of services, such as the directory or the mechanism for requests.

In one application of the service oriented type, the system can comprise:
A middleware application having notably the function of supporting services for a service oriented architecture;
A network routing mechanism for relaying the messages, in radio multi-jump mode for example;
Optionally, for cases of specific applications, a positioning system when the deployments of tasks must be carried out in a particular geographic region; in this case, the position of the node must be known.

The example that follows is presented in the framework of a service oriented approach for data fusion with the aim of facilitating the understanding of the invention without limiting its possible applications.

For a network of the WSN type equipped with a service oriented middleware application, three types of components involved in the dynamic creation of services or of distributed fusion processing operations are identified and illustrated in FIG. 4:

The local sensor services A, B, C: these are the default services available on the nodes. They may be functionally associated with sensor modules, for example transducers. These services can be of varying sophistication. For example, they allow the following to be obtained:
the latest value measured by invocation,
the value measured in the case of a significant change by using the management capacities which could be those of the SOA middleware,
the basic operations 21a, 21b, 21c; these are for example a function library and operations enabling the manipulation or processing of the data, for example, filtering, the average, the aggregation, the combination,
the ‘deployed services 22a, 22b, 22c’; these services or tasks are components deployed on the WSN nodes. They use the aforementioned two types of components, whether they are in local mode on the node or on a remote node, in order to implement the distributed fusion service in the WSN.

The availability of the library of ‘basic operations’ is not a pre-requisite to the implementation of the method. This is highly dependent on the nature of the processing operations that may be implemented within the ‘deployed services’. On the other hand, the presence of this library is used where the operating system on the WSN nodes does not allow code to be deployed ‘live’ or in real time.

FIG. 4 illustrates the manner in which these components interact. Thus, a detection service or ‘task’ 22 deployed on the sensor node C uses the positioning service in local mode 24, another service 22b deployed on the node B, together with data processing operations available in local mode on the node B. Similarly, the service 22b deployed on the node B uses the service offering the resources of the magnetometer 24a on the node A, together with data processing operations available in local mode.

The requested services are represented schematically in the figure by a half-crescent 25 and the services provided by a circle 26.
Division into tasks:

The tasks to be carried out by the sensor nodes can be assembled in the form of a master file an example of which is given in FIG. 5. This master file allows specific tasks to be allocated to the sensor nodes according to certain properties such as, for example, their identifier, their position or the geographical region where they are located.

The description of the tasks is done in two main ways:
Code to be executed on the WSN nodes if the operating system running on these nodes allows live deployment of the code, or
Scripts to be interpreted on the WSN nodes.

Examples of scripts are given in FIGS. 6, 7 and 8 for illustration. FIG. 6 specifies a script for sending a warning if a monitored modality exceeds a pre-determined threshold; FIG. 7, sending a warning if two monitored modalities, or parameters (e.g., temperature and light intensity) both exceed a threshold value. FIG. 8 is an example of script where it is desired to expose a new service to the other sensor nodes.

The system or device enabling the implementation of the steps of the method described hereinabove, and hence the distribution of distributed cooperating processing operations in the wireless sensor networks, for example, in the framework of the example relating to a service oriented approach, described by way of example and in a non-limiting manner, notably comprises the following elements illustrated in FIG. 9:

40—Task deployment manager: This module allows the tasks to be processed on a node to be received from a gateway not shown in the figure for reasons of simplification. It allows the life cycle of the deployed tasks to be managed. The gateway allows communications with the world outside of the system according to the invention. A task can be in various states in the course of its life cycle:

Installed: when the code has been correctly deployed in the node using the gateway.

Halted: when any potential dependences vis-à-vis other services or components have been resolved, but the task is not being run.

Started: when the task is being run.

Uninstalled: when, once halted, the task is deleted from the deployment manager and the associated resources freed up.

41—Task repository: This module stores the various tasks received via the task deployment manager 40.

42—Allocated memory: This module can be used to store the variables used by the tasks. The allocation can be carried out dynamically but, where very low capacity sensor nodes such as the MICAz are used, it is carried out statically in principal by the node gateway. In this latter case, the size of the allocated memory is bounded by a maximum.

43—Task processor: This module manages the execution of the tasks located in the task repository module 41. It executes each of the instructions by making use of the basic operations 44, by recovering the local or remote modality values coming from the local sensor services 45 of the current node or other nodes of the network, by recovering the modality values created dynamically via the dynamic services manager 46.

44—Basic operations: This module contains the basic operations that the various tasks can use in a sequential fashion. These can for example be operations for:
Access to remote or local modalities
Threshold detection
Filtering
Aggregation
Decision
Creation of dynamic services
   Since these operations are known to those skilled in the art, they will not be further explained in the present Patent application.

45—Local sensor services: This module contains all of the local services exposing the default modalities available on the node.

46—Dynamic services manager or Service broker: This module manages the services created dynamically allowing the nodes to exchange new modalities. Thus, when a new modality is made available locally by a task, this module creates a service allowing the other nodes of the network to discover it and to access it. The service notably establishes contact between the tasks of the various nodes delivering and consuming services via the service oriented communications module 47. This module or manager comprises at least one module for discovering new services offered by one or more of the other nodes of the network.

47—A service oriented communications module exposing the internal functionalities of other nodes of the network through input and output interfaces formally described in the form of an ‘interface contract’ and allowing services on other nodes of the network to be controlled. In one non-limiting application example, the communications module is a stack of the WSN-SOA type.

The presence and the mutual interaction of these various elements and modules on a node allow processing operations to be distributed in the framework of a fusion service. This therefore allows the communication costs to be reduced that are required by a centralised method in which all the data are downloaded over the gateway nodes.

The modules 43, 45, 46, 40 are in contact with a WSN-SOA stack, itself in communication with the operating system TinyOS.

This method offers a high tolerance to faults. In the case of the failure or disappearance of a sensor, the distributed fusion service can be totally or partially reconfigured in order to modify the placement of the processing operations and of the various modalities used.

Without straying from the scope of the invention, some or all the elements described hereinabove can be implemented in wired networks.

As has been previously defined for the multi-level architecture in FIG. 2, the master nodes are generally devices with superior capacities in terms of processing, connectivity and autonomy, such as devices with an onboard GNU/Linux operating system or else a virtual Java machine. In these environments, the processing capacities allow the use of existing task deployment mechanisms. When a virtual Java machine is available, software plug-ins such as OSGi are particularly well adapted since they allow updates to be carried out without rebooting the system and the life cycle of the deployed tasks to be managed.

The role of the ‘master nodes’ is to collect information from the distributed processing operation deployed in the WSN network and to present it as a high-level functionality to the information processing system, while masking the underlying complexity.

The deployment system that can be implemented on a ‘master node’ is composed, for example, of the modules with the elementary functionalities shown in FIG. 10:

51—Task master repository: this module stores the various ‘master files’ each containing tasks to be deployed. These files are deposited by the services of the Web Services type hosted or deployed on the ‘master node’.

52—Tasks pre-processor: this module prepares each of the tasks stored in the task master repository 51 so that they are deployed later by the task deployment manager 56. This module can for example ‘binarise’ the scripts in a suitable format, pre-allocate the memory using the memory manager 53 and specify the addressing for the services using the service management module 54.

53—Memory Manager: this module can be used to allocate the memory used by the tasks in the case where sensor nodes are used that do not support the dynamic allocation of memory. In this latter case, a memory space, known to this module, has been pre-allocated on the sensor nodes.

54—Global Service Registry: this module keeps a list of the nodes and of their services up to date and allows the addressing of the services, which was global in the ‘master file’, to be transformed into dedicated addressing in the deployed tasks.

55—Node Locator: this module is responsible for maintaining the information relating to the node positions. It assists the task deployment manager in the deployment, telling it, where necessary, on which sensor a task must be deployed.

56—Task Deployment manager: this module carries out the deployment of a task on a sensor by communicating with its peer module present on the sensor nodes. It should be noted that the deployment of the tasks can also be carried out in an epidemic manner in some cases.

57—Service Gateway: once the distributed fusion service has been deployed in the WSN, this module allows the highest level service to communicate with the latter in a bi-directional manner. The gateway module notably has the function of ensuring the interoperability between the tasks running on sensor nodes Ni having limited processing capacities and services or tasks running on unconstrained nodes or on an information processing system.

The service gateway 57 is in communication with the service oriented communications module 47, which can be a WSN-SOA stack, and the Web services 50.

58—A storage module for the pre-processed tasks (tasks that are processed upstream of the system according to the invention) can be disposed upstream of the mediation module 56 in the case where the tasks executed on the master node originate from modules external to the system according to the invention.

59—A service oriented communications module, equivalent to the module 47 for ‘master nodes’.

The method and the devices disposed at the nodes can also be used for orchestration needs, in other words when one or more master nodes impose(s) and manage(s) the sequence of actions on the sensor nodes of a network. For example, it may be required that the detection of a presence by a sensor triggers the switching on of a light controlled by another sensor. In other words, this method is applicable to networks composed of entities with very low capacities that can equally well play the role of sensor transforming the physical phenomena into electrical signals or of effecter allowing electrical signals to be transformed into physical phenomena.

The following part of the description illustrates the manner in which distributed fusion services may be deployed on various types of nodes, preferably nodes with limited capacity. The following example will use the coordination by a master entity of a succession of calls to various services generally distributed within the network which is referred to as ‘orchestration’ and the common and complementary behaviour between the services involved in a distributed processing operation, without one single node being coordinator, which is referred to as ‘choreography’.

FIG. 11 shows one example of dynamic deployment of a simple distributed fusion system:

Each low-capacity node A and B runs a task deployment manager 40 and a storage module 41 with components deployed by default which include the ‘elementary services’ that it is desired to be able to use. For example, the node A comprises a positioning system for the node 60, a detection system 61, and the node B comprises a fusion algorithm 63. The circles 65 symbolise a functionality made available to the other local components (when they are shown inside the node) or exposed as a service to other nodes (when they are shown outside). The brackets or half-moons 66 symbolise that a functionality is requested by a component. The lines connect the functionalities delivered and requested. The dashed-line figures symbolise the new components and relationships that are the result of the dynamic deployment.

In this example of dynamic deployment of distributed processing operation, two new tasks are deployed: on the node A, a new target detection task 62 uses the existing functionalities of detection and of positioning and exposes its functionality as a new service which is available upon request to all the other nodes; on the node B, a new distributed target detection task 64 uses the module 63 and calls upon the remote target detection task service 62. Its result is exposed to the rest of the network as a new service which masks the complexity of the underlying distributed operation.

The same example with higher capacity nodes can use existing technologies such as OSGi for the live deployment of new components and the management of their life cycle and of additional communication mechanisms, such as the aforementioned DPWS service, in order to expose the functionalities as services so as to uncover and consume them using other nodes.

FIG. 12 describes the complete method, from the design phase of the distributed processing operation as far as its deployment on the network of nodes with non-uniform capacities. This part describes one of the possible mechanisms for addressing the deployment of distributed fusion processing operations on a non-uniform system combining the nodes with limited capacity and WSN network nodes. The approach chosen emphasizes the interoperability with the existing standards and tools. The reference 71 shows an orchestration schematic flow diagram, in other words an example of a succession of tasks to be executed on various nodes 1, . . . , 8 accessible via a gateway. The tool 71 notably allows a global description of the behaviour of the distributed processing to be constructed starting from a library of basic functions 70 and from a module 72 transforming the said description into a set of individual tasks designed to be deployed on each of the sensors Ni. Thus, the global description system for the distributed processing and the library of basic functions allow tasks designed for nodes having non-uniform processing capacities to be defined and the associated deployment module 74 allows the individual tasks generated 73₁, 73₂, 73₃, 73₄ on nodes with non-uniform capacities to be deployed, for example 73₁ on A, 73₂, 73₃, 73₄ on 1, 2, 3, the said nodes communicating with the service gateway 57

The first step consists in describing the behaviour of the distributed processing starting from the library of basic functions 70 encapsulating pre-defined functionalities, whether this be:
For low-capacity nodes, for example: average, threshold detection, etc.
For higher capacity nodes, for example FFT (Fast Fourier Transform), operations on databases, etc.

This behaviour is described using existing graphics tools 70 or tools designed for the definition of choreography and orchestrations.

Once the processing has been defined, the output files in XML format are read and processed by a compiler 72 which, based on the library of components 70, creates individual tasks 73₁, 73₂, 73₃, 73₄ for each node; for example, a script for the low-capacity nodes and an OSGi bundling for those with lesser constraints.

A terminal 74 then allows the process of deployment onto the chosen network 75 of nodes to be controlled.

A module for supervision and management of the deployed tasks 76 allows the execution of the tasks deployed on the sensor nodes to be simulated, tested, supervised and reconfigured based on the description of the global behaviour of the distributed processing 71.

The method according to the invention advantageously allows processing operations able to collaborate with one another to be deployed on an array of sensor nodes in order to create a distributed data fusion service. The processing operation deployed within each node is a succession of various functions called ‘tasks’. It is exposed to the rest of the nodes as a service. The global behaviour of the array of sensors, in other words the succession of the exchanges between the various tasks of each node, is named ‘distributed processing’. Its result is presented as a high-level service delivered by a single macro sensor. This allows a distributed multi-level architecture to be implemented for data fusion.

The method according to the invention notably offers the possibility:
of describing the tasks allocated to the sensor nodes using dedicated primitives for the data fusion,
of deploying and executing these tasks on the sensor nodes without the necessity of rebooting the nodes,
of supporting the mutual collaboration of the tasks using a service oriented approach,
of distributing data fusion processing operations involving the collaboration of WSN network nodes using a service oriented approach,
of interoperating with existing service oriented approaches from the IP or other worlds, within the framework of a multi-level collaborative distributed processing architecture for data fusion.

1. System enabling the dynamic deployment and/or the creation of tasks within a network comprising at least one master node (0) and several sensor nodes Ni having limited processing capacities, the network supporting a communications software application exposing the functionalities of each sensor node as services on the said network and a mediation mechanism allowing communications between the services of various sensor nodes of the said network to be established wherein it comprises at least the following elements:
At a low-capacity node Ni of the network:
A task or processing operations deployment manager (40),
A storage module (41) for the said tasks received via a deployment manager for the tasks (40),
A processor module (43) for the said tasks, the said module using basic operations (44) present in the said node,
An interface with local sensors (45),
A service oriented network communications module (47), exposing the functionalities internal to other nodes of the network via input and output interfaces and allowing the said services to be controlled on other nodes,
A global mediation module (46) establishing communications between the tasks of the various nodes, delivering and consuming one or more of the said services via the service oriented communications module (47),
the said various sensor nodes within the said network each executing one or more of the specific deployed tasks,
At a master node used in the deployment phase:
A task deployment manager (56).

2. System according to claim 1, wherein the module for the basic operations (44) of a node Ni of the network comprises at least one operation allowing a task executed on the said node to dynamically create a new service which will be exposed across the said network.

3. System according to claim 1, wherein the said global service mediation module (46) for a node Ni of the network comprises at least one module for uncovering the new services offered by one or more of the other nodes of the network.

4. System for the dynamic creation of services or of distributed processing operations according to claim 1, wherein the system further comprises a tool (71) allowing a description of the behaviour of a distributed processing operation to be globally generated starting from a library of basic functions (70) and a module (72) transforming the said description into a set of individual tasks (73₁), (73₂), (73₃), (73₄), designed to be deployed on each of the sensor nodes Ni.

5. System according to claim 1, wherein at least one node comprises a service gateway (57) designed to ensure interoperability between the tasks being executed on sensor nodes Ni having limited processing capacities and services or tasks being executed on unconstrained nodes or on an information processing system.

6. System according to claim 4, wherein the system for global description of the distributed processing operation (71) and the library of basic functions (70) allow tasks to be defined that are designed for nodes having non-uniform processing capacities, and the associated deployment module (74) allows individual tasks generated (73₁), (73₂), (73₃), (73₄) to be deployed over nodes with non-uniform capacities, communicating via the said service gateway (57).

7. System according to claim 6, wherein the system further comprises a module for supervision and management of the tasks deployed (76), allowing the execution of the tasks deployed over the sensor nodes to be simulated, tested, supervised and reconfigured using the description of the global behaviour of the distributed processing operation (71).

8. System according to claim 1, wherein the communications module (47) is a stack of the WSN-SOA type.

9. System according to claim 5, wherein the system for global description of the distributed processing operation (71) and the library of basic functions (70) allow tasks to be defined that are designed for nodes having non-uniform processing capacities, and the associated deployment module (74) allows individual tasks generated (73₁), (73₂), (73₃), (73₄) to be deployed over nodes with non-uniform capacities, communicating via the said service gateway (57).

10. System according to claim 4, wherein the system further comprises a module for supervision and management of the tasks deployed (76), allowing the execution of the tasks deployed over the sensor nodes to be simulated, tested, supervised and reconfigured using the description of the global behaviour of the distributed processing operation (71).
